(19) United States
(12) Patent Application Publication
(10) Pub. No.: US 2011/0057433 A1
(43) Pub. Date: Mar. 10, 2011

(54) NOTEBOOK APPARATUS AND METHOD

(75) Inventors: Harolde M. Savoy, Dallas, TX (US); Claude Bélisle, Saint-Jean-sur-Richelieu (CA); Claude Charbonneau, Saint-Jean-sur-Richelieu (CA); Stéphane Massicotte, Saint-Jean-sur-Richelieu (CA); Marjorie Roy, Saint-Jean-sur-Richelieu (CA)

(73) Assignee: LES ENTREPRISES DOMINION BLUELINE INC., Saint-Jean-sur-Richelieu, QC (CA)

(21) Appl. No.: 12/877,552

(22) Filed: Sep. 8, 2010

Related U.S. Application Data
(60) Provisional application No. 61/240,800, filed on Sep. 9, 2009.

(51) Int. Cl. B42D 1/00

(52) U.S. Cl. 281/27.2

(57) ABSTRACT

A notebook and/or a sheet of material therefor according to which an opening is formed through the sheet, and the shape of the opening defines a generally rounded edge of the sheet, and generally straight edges of the sheet. In an exemplary embodiment, the notebook is a wirebound or ring-bound notebook.

### CROSS REFERENCE TO RELATED APPLICATION

This application claims the benefit of the filing date of U.S. provisional patent application No. 61/240,800, filed Sep. 9, 2009, the entire disclosure of which is incorporated herein by reference.

### BACKGROUND

This disclosure relates in general to books, such as notebooks, and sheets or pages therefor, and in particular to wirebound or ring-bound books, such as wirebound or ring-bound notebooks, and sheets or pages therefor.

### BRIEF DESCRIPTION OF THE DRAWINGS

FIG. 1 is a perspective view of a notebook in a closed configuration, according to an exemplary embodiment, the notebook including a wire binding and sheets of paper coupled thereto.

FIG. 2 is a perspective view of the notebook of FIG. 1 in an open configuration, according to an exemplary embodiment.

FIG. 3 is a front elevational view of one of the sheets of paper of the notebook of FIGS. 1 and 2, according to an exemplary embodiment.

FIG. 4 is an enlarged view of a portion of FIG. 3.

FIG. 5A is a view similar to that of FIG. 4, but further depicts a portion of the wire biding of FIGS. 1 and 2, according to an exemplary embodiment.

FIG. 5B is a sectional view of the sheet of paper and the portion of the wire binding taken along line 5B-5B of FIG. 5A, according to an exemplary embodiment.

FIG. 6 is a perspective view of the respective portions of the sheet of paper and the wire binding of FIGS. 5A and 5B as the sheet is pivoted relative to the binding, according to an exemplary embodiment.

FIG. 7 is a perspective view of the notebook of FIGS. 1 and 2 as the sheet of paper of FIGS. 3-6 is decoupled from the wire binding, according to an exemplary embodiment.

FIG. 8A is a perspective view of the notebook of FIGS. 1 and 2 and depicts the sheet of paper of FIGS. 3-6 prior to its recoupling to the wire binding, according to an exemplary embodiment.

FIG. 8B is an enlarged view of portion of FIG. 8A.

FIGS. 8C and 8D are views similar to that of FIG. 8A, but depict the recoupling of the sheet of paper of FIGS. 3-6 to the wire binding, according to an exemplary embodiment.

### DETAILED DESCRIPTION

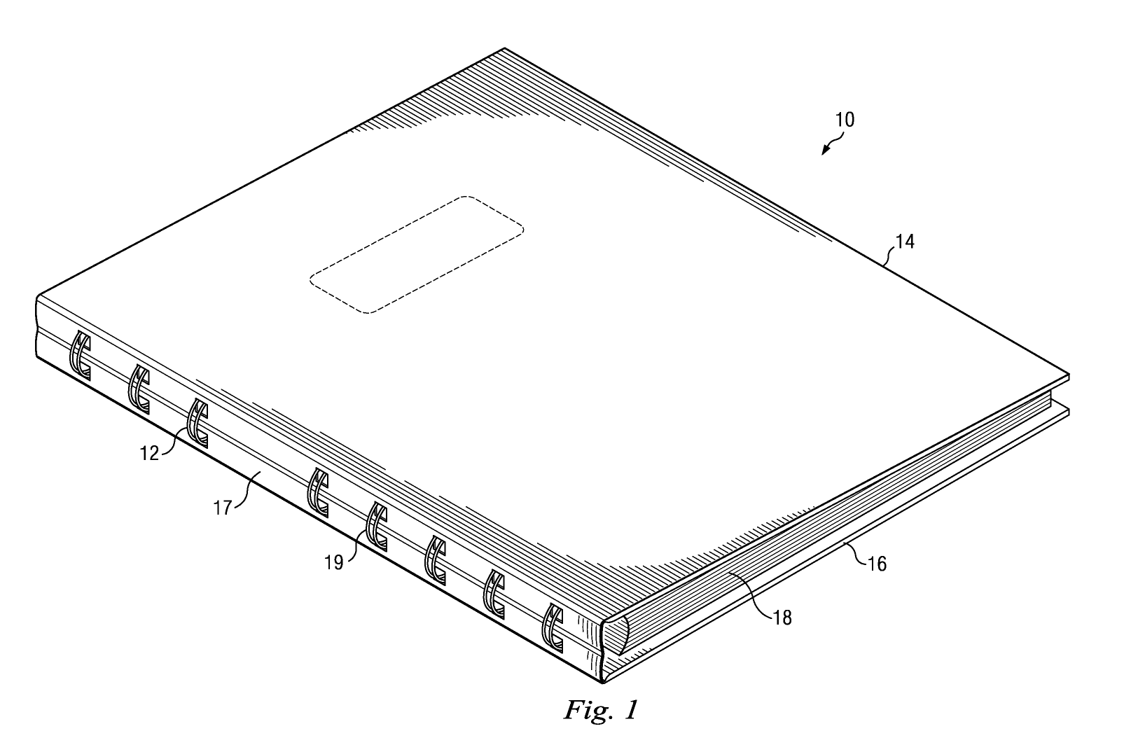

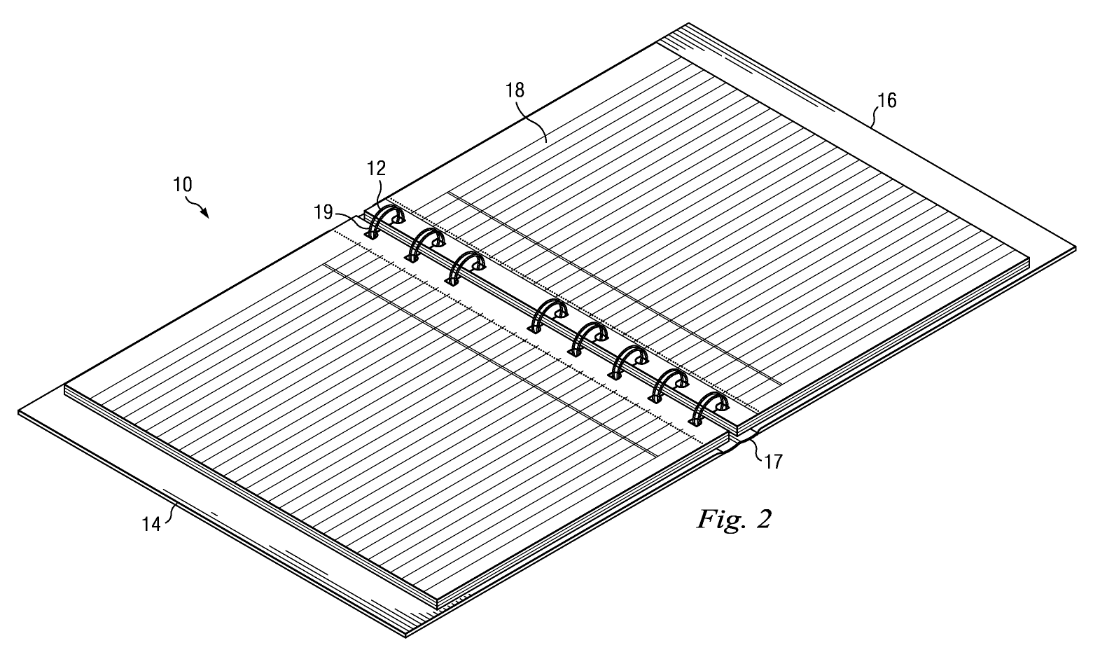

In an exemplary embodiment, as illustrated in FIGS. 1 and 2, a notebook is generally referred to by the reference numeral 10 and includes a binding 12, a front cover 14, a back cover 16, a spine 17, and sheets of material, such as sheets of paper 18. The covers 14 and 16, the spine 17, and the sheets of paper 18, are coupled to the binding 12. The spine 17 extends between the covers 14 and 16. The notebook 10 may be placed in a closed or open configuration, as shown in FIGS. 1 and 2, respectively. When the notebook 10 is in the closed configuration shown in FIG. 1, the sheets of paper 18 are disposed between the covers 14 and 16. In an exemplary embodiment, instead of, or in addition to sheets of paper 18, sheets of other types of material are coupled to the binding 12 such as, for example, sheets of plastic and/or cardboard.

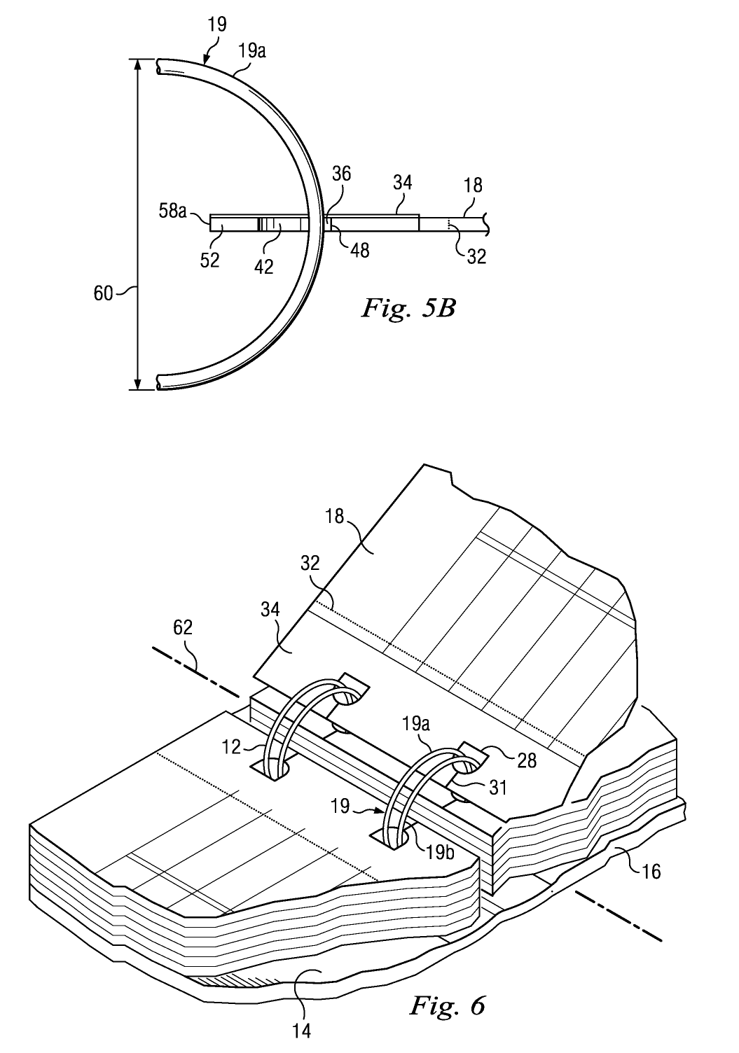

In an exemplary embodiment, the binding 12 includes a plurality of axially-spaced, circumferentially-extending binding elements 19, each of which defines a diameter (shown in FIG. 5B). In an exemplary embodiment, each of the binding elements 19 includes one or more wire loops, which are coupled to one another via axially-extending segments (not shown) of the wire used to form the wire loops. In an exemplary embodiment, each of the binding elements 19 includes two wire loops, the binding 12 is a “double loop wire binding” or a “twin loop wire binding,” and the notebook 10 is a wirebound notebook. In several exemplary embodiments, instead of, or in addition to wire loops, the circumferentially-extending binding elements 19 of the binding 12 include respective axially-spaced rings, which are coupled to the spine 17. In an exemplary embodiment, the binding elements 19 include respective rings, and the notebook 10 is a ring-bound notebook.

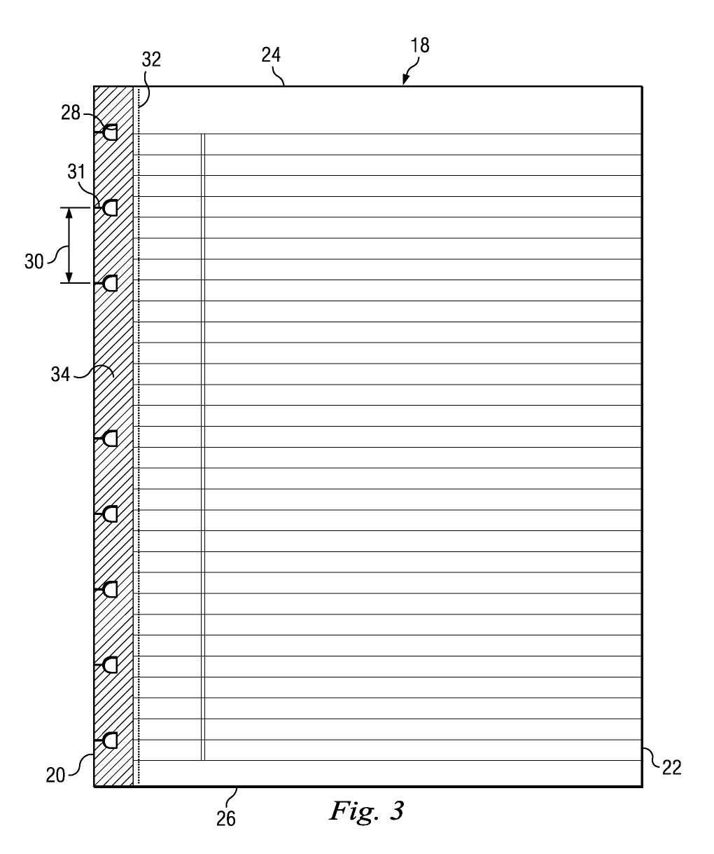

In an exemplary embodiment, as illustrated in FIG. 3 with continuing reference to FIGS. 1 and 2, each of the sheets of paper 18 includes a left edge 20, a right edge 22, a top edge 24, and a bottom edge 26. Openings 28 are formed through the sheet of paper 18, and are spaced from each other in a direction parallel to the left edge 20, with each of the respective spacings defining a dimension 30. Cuts 31 are formed through the sheet of paper 18. Each of the cuts 31 extends from the left edge 20 to a respective one of the openings 28. The cuts 31 are spaced in a parallel relation by the dimension 30. A perforated line 32 is formed in the sheet of paper 18, and is spaced in a parallel relation from the left edge 20 so that the openings 28 are disposed between the left edge 20 and the perforated line 32. A reinforcing medium 34 is coupled to the sheet of paper 18, and extends along the left edge 20. The openings 28 extend through the reinforcing medium 34. In an exemplary embodiment, the reinforcing medium 34 is, or at least includes, a plastic segment, a cardboard segment, paper having a heavier weight than the rest of the sheet of paper 18, and/or any combination thereof. In an exemplary embodiment, the reinforcing medium 34 is, or includes, a urethane reinforcing medium, and/or one or more polymeric materials.

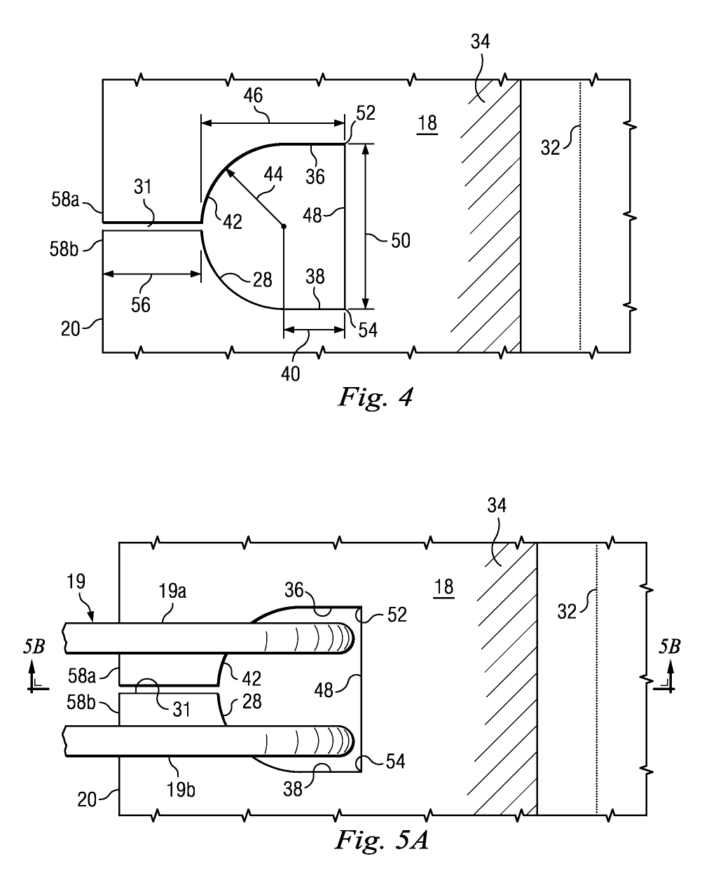

In an exemplary embodiment, as illustrated in FIG. 4 with continuing reference to FIGS. 1-3, each of the openings 28 has a shape that defines parallel-spaced edges 36 and 38 of the sheet of paper 18. Each of the edges 36 and 38 is generally perpendicular to the left edge 20, is generally straight, and defines a dimension 40. The shape of each of the openings 28 further defines a generally rounded edge 42, which extends from the left end (as viewed in FIG. 4) of the edge 36 to the left end (as viewed in FIG. 4) of the edge 38. The rounded edge 42 defines a radius 44, and is disposed between the left edge 20 and the respective left ends (as viewed in FIG. 4) of the edges 36 and 38. A dimension 46 is defined by the extension of each of the edges 36 and 38, and the extension of the rounded edge 42. The dimension 46 is generally equal to the sum of the dimension 40 and the radius 44. The shape of each of the openings 28 further defines a generally straight edge 48, which extends from the right end (as viewed in FIG. 4) of the edge 36 to the right end (as viewed in FIG. 4) of the edge 38. The edge 48 is generally parallel to the left edge 20, and is generally perpendicular to each of the edges 36 and 38. The edge 48 defines a dimension 50, which is generally equal to twice the radius 44. A corner 52 is defined by the intersection of the edge 48 with the right end (as viewed in FIG. 4) of the edge 36. A corner 54 is defined by the intersection of the edge 48 with the right end (as viewed in FIG. 4) of the edge 38.

As shown in FIG. 4, each of the cuts 31 extends from the left edge 20 to the rounded edge 42, is generally perpendicular to the left edge 20, is disposed generally midway between the respective left ends (as viewed in FIG. 4) of the edges 36 and 38, and defines a dimension 56. An upper tab portion 58a of the sheet of paper 18 is defined by the cut 31 and the portion of the rounded edge 42 that extends between the cut 31 and the edge 36. A lower tab portion 58b of the sheet of paper 18 is defined by the cut 31 and the portion of the rounded edge 42 that extends between the cut 31 and the edge 38. In an exemplary embodiment, the dimension 30 (i.e., the spacing between the cuts 31 shown in FIG. 3) is about 1 inch.

In an exemplary embodiment, the dimension 40 is about 2.75 mm, the radius 44 is about 3 mm, the dimension 46 is about 5.75 mm, the dimension 50 is about 6 mm, and the dimension 56 is about 4 mm. In an exemplary embodiment, the dimension 40 is about 2 mm, the radius 44 is about 2.75 mm, the dimension 46 is about 4.75 mm, the dimension 50 is about 5.5 mm, and the dimension 56 is about 3 mm. In an exemplary embodiment, the dimension 40 ranges from about 2 mm to about 2.75 mm, the radius 44 ranges from about 2.75 mm to about 3 mm, the dimension 46 ranges from about 4.75 mm to about 5.75 mm, the dimension 50 ranges from about 5.5 mm to about 6 mm, and the dimension 56 ranges from about 3 mm to about 4 mm. In an exemplary embodiment, the length of each of the edges 20 and 22 is about 9¼ inches or about 235 mm, and the length (or width) of each of the edges 24 and 26 is about 7¼ inches or about 184 mm. In an exemplary embodiment, the ratio of the dimension 56 to the sum of the dimension 56, the radius 44 and the dimension 40 ranges from about 0.39 to about 0.41, the ratio of the radius 44 to the sum of the dimension 56, the radius 44 and the dimension 40 ranges from about 0.31 to about 0.35, and the ratio of the dimension 40 to the sum of the dimension 56, the radius 44 and the dimension 40 ranges from about 0.26 to about 0.28.

In an exemplary embodiment, as illustrated in FIGS. 5A and 5B with continuing reference to FIGS. 1-4, each of the binding elements 19 extends through a respective one of the openings 28 so that the sheet of paper 18 is coupled to the binding element 19. Each of the binding elements includes wire loops 19a and 19b, which are coupled to one another via axially-extending segments (not shown) of the wire used to form the wire loops. Each of the binding elements 19 defines a diameter 60 (FIG. 5B). The wire loops 19a and 19b extend through the opening 28 so that a portion of the binding element 19 is disposed between the rounded edge 42 and the edge 48 in a direction that is generally perpendicular to the left edge 20 of the sheet of paper 18. Moreover, respective portions of the left edge 20 and the rounded edge 42 are disposed between opposing tangential points of each of the wire loops 19a and 19b of the binding element 19, as indicated in FIGS. 2, 5A and 5B.

In an exemplary embodiment, the diameter 60 is about 1 inch, the dimension 40 is about 2.75 mm, the radius 44 is about 3 mm, the dimension 46 is about 5.75 mm, the dimension 50 is about 6 mm, and the dimension 56 is about 4 mm. In an exemplary embodiment, the diameter 60 is about ½ inch, the dimension 40 is about 2 mm, the radius 44 is about 2.75 mm, the dimension 46 is about 4.75 mm, the dimension 50 is about 5.5 mm, and the dimension 56 is about 3 mm. In an exemplary embodiment, the diameter 60 ranges from about ½ inch to about 1 inch, the dimension 40 ranges from about 2 mm to about 2.75 mm, the radius 44 ranges from about 2.75 mm to about 3 mm, the dimension 46 ranges from about 4.75 mm to about 5.75 mm, the dimension 50 ranges from about 5.5 mm to about 6 mm, and the dimension 56 ranges from about 3 mm to about 4 mm. In an exemplary embodiment, the diameter 60 ranges from about ½ inch to about 1 inch, the ratio of the dimension 56 to the sum of the dimension 56, the radius 44 and the dimension 40 ranges from about 0.39 to about 0.41, the ratio of the radius 44 to the sum of the dimension 56, the radius 44 and the dimension 40 ranges from about 0.31 to about 0.35, and the ratio of the dimension 40 to the sum of the dimension 56, the radius 44 and the dimension 40 ranges from about 0.26 to about 0.28.

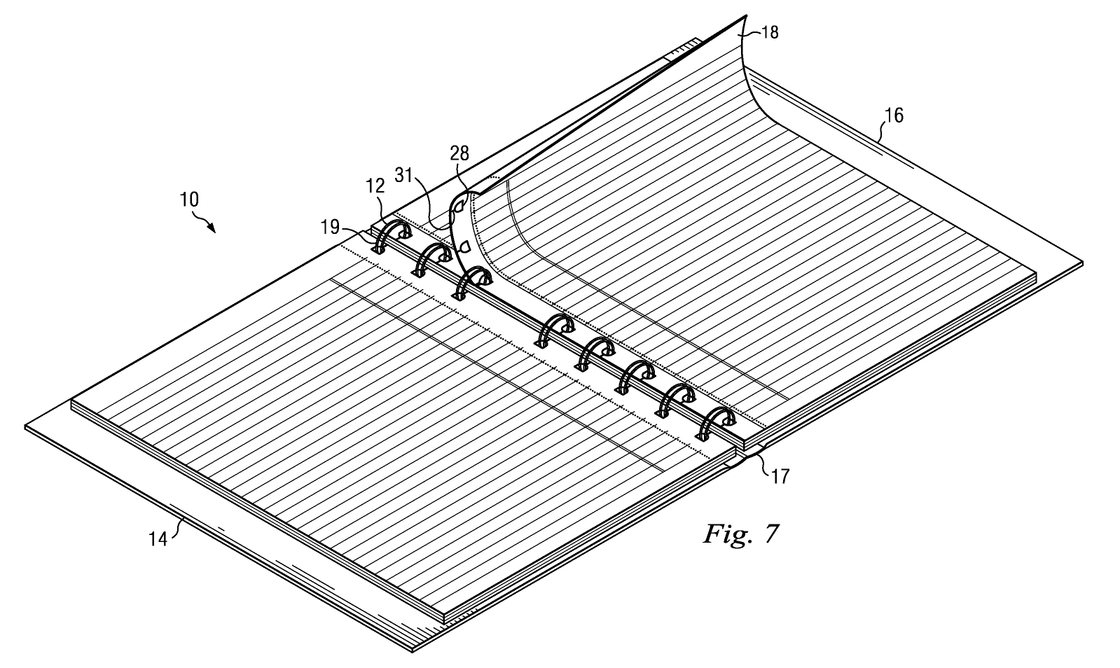

In operation, in an exemplary embodiment, as illustrated in FIG. 6 with continuing reference to FIGS. 1-5B, each of the sheets of paper 18 is permitted to pivot, relative to each of the binding elements 19, about an axis 62, which is generally perpendicular to the respective planes in which the binding elements 19 circumferentially extend. A user of the notebook 10 can thus turn the sheets of paper 18, with the sheets of paper 18 pivoting about the axis 62 during the turning. In an exemplary embodiment, the respective rounded shapes of the rounded edges 42 avoid, or at least resist, any tearing or damage to the sheet of paper 18 that may occur as a result of the sheet of paper 18 rubbing against or otherwise contacting the corresponding binding elements 19 during the pivoting of the sheet of paper 18, relative to the binding elements 19. In an exemplary embodiment, the absence of any right-angle or sharp corners along each of the rounded edges 42 and its interaction with each of the corresponding edges 36 and 38 avoids, or at least resists, any tearing or damage to the sheet of paper 18 that may occur as a result of the sheet of paper 18 rubbing against or otherwise contacting the binding elements 19 during the pivoting of the sheet of paper 18, relative to the binding elements 19. In an exemplary embodiment, the respective pairs of corners 52 and 54 facilitate the pivoting of the sheet of paper 18, relative to the binding elements 19, about the axis 62. In an exemplary embodiment, the respective pairs of corners 52 and 54 facilitate the pivoting of the sheet of paper 18, relative to the binding elements 19 and about the axis 62, by improving relative mobility between the sheet of paper 18 and the binding elements 19. In an exemplary embodiment, the respective pairs of corners 52 and 54 facilitate the pivoting of the sheet of paper 18, relative to the binding elements 19 and about the axis 62, by increasing or at least providing nominal respective clearances between each of the binding elements 19 and the corresponding edges 36, 38 and 48. In an exemplary embodiment, the presence of the corners 52 and 54 prevent or at least limit any “squeezing” of the wire loops 19a and 19b, or contact against the wire loops 19a and 19b, by the sheet of paper 18 during its pivoting about the axis 62.

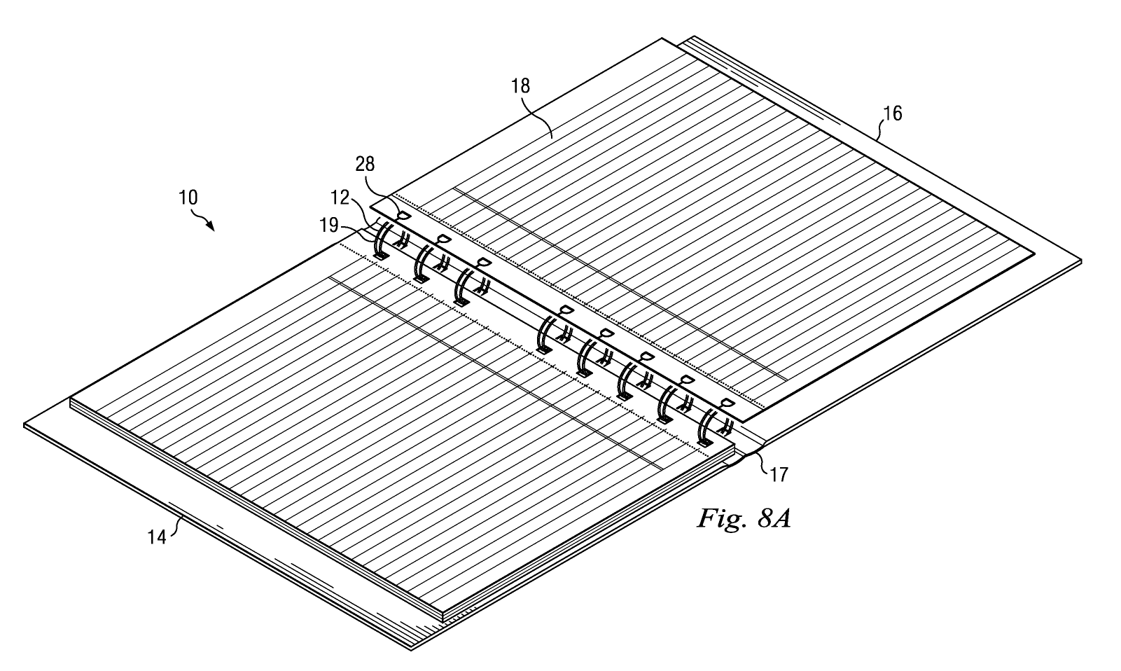

During operation, in an exemplary embodiment, as illustrated in FIG. 7 with continuing reference to FIGS. 1-6, one or more of the sheets of paper 18 may be decoupled from the binding 12 and thus removed from the notebook 10. As shown in FIG. 7, one of the sheets of paper 18 is decoupled from the binding elements 19 and thus from the binding 12 by, for example, pulling the sheet of paper 18 away from the binding 12. The cuts 31 formed in the sheet of paper 18 permit relative movement between the sheet of paper 18 and the binding elements 19 to thereby permit the decoupling of the sheet of paper 18. More particularly, the binding elements 19 pass through the respective cuts 31 as the sheet of paper 18 is decoupled from the binding 12. In several exemplary embodiments, the binding elements 19 pass through the respective cuts 31 in a direction that is parallel to the direction of extension of the cuts 31, a direction that is perpendicular to the direction of extension of the cuts 31, and/or any combination thereof.

In an exemplary embodiment, as the binding elements 19 pass through the respective cuts 31, each of the respective pairs of tab portions 58a and 58b of the sheet of paper 18 bend against or otherwise contact the respective wire loops 19a and/or 19b. The respective rounded shapes of the rounded edges 42 resist any tearing or damage to the sheet of paper 18 during the decoupling of the sheet of paper 18 from each of the binding elements 19, reducing instances of tearing or curling and facilitating any reinsertion, refilling or coupling of the sheet of paper 18 to the binding 12 subsequent to the decoupling (discussed in further detail below).

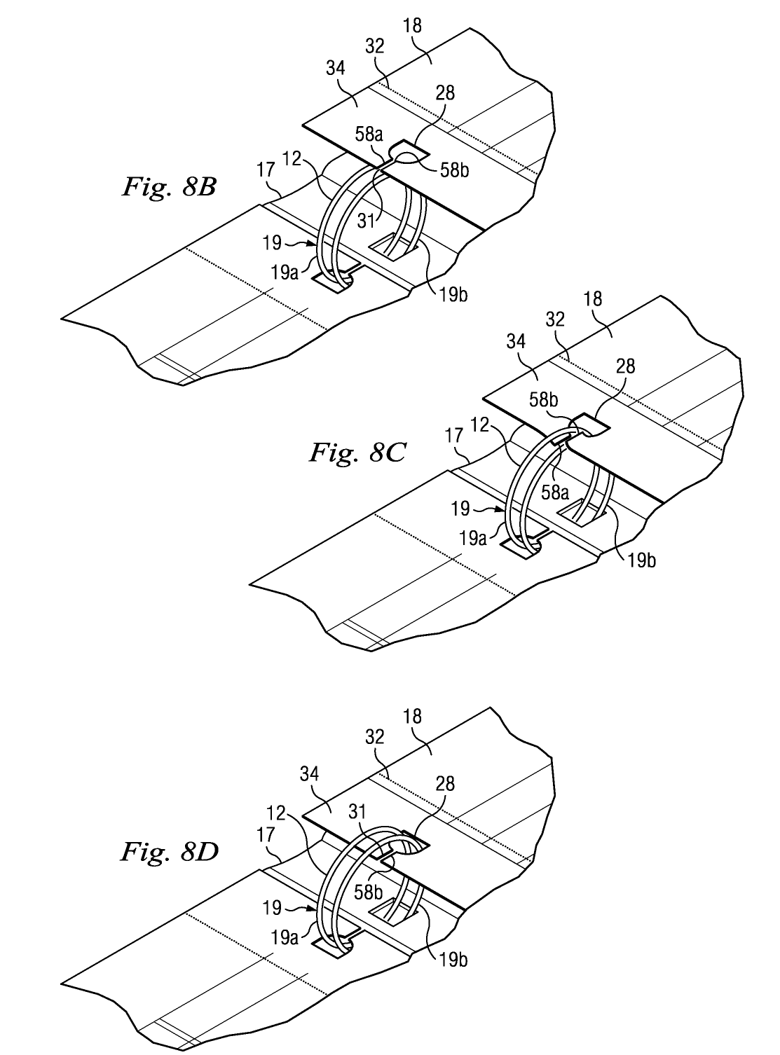

During operation, in an exemplary embodiment, as illustrated in FIGS. 8A-8D with continuing reference to FIGS. 1-7, the sheet of paper 18 that has been decoupled from the binding 12 is refilled or reinserted into the notebook 10, that is, recoupled to the binding 12. The decoupled sheet of paper 18 may be recoupled to the binding 12 at its original position or it may be repositioned within the notebook 10 before being recoupled to the binding 12. For example, as shown in FIG. 8A, the sheet of paper 18 that has been decoupled from the binding 12 (as described above and shown in FIG. 7) is repositioned at the back of the notebook 10.

As shown in FIGS. 8B, 8C and 8D, each of the cuts 31 permits relative movement between the decoupled sheet of paper 18 and the corresponding binding element 19 to thereby permit, subsequent to the decoupling, the coupling of the sheet of paper 18 to the binding elements 19 (and thus the binding 12) by, for example, pushing the respective pairs of tab portions 58a and 58b against the respective binding elements 19. More particularly, the binding elements 19 pass through the respective cuts 31 as the sheet of paper 18 is recoupled to the binding 12. In several exemplary embodiments, the binding elements 19 pass through the respective cuts 31 in a direction that is the parallel to the direction of extension of the cuts 31, a direction that is perpendicular to the direction of extension of the cuts 31, and/or any combination thereof.

In an exemplary embodiment, as the binding elements 19 pass through the respective cuts 31, each of the respective pairs of tab portions 58a and 58b of the sheet of paper 18 bend against or otherwise contact the respective wire loops 19a and/or 19b. The respective rounded shapes of the rounded edges 42 resist any tearing or damage to the sheet of paper 18 during the recoupling of the sheet of paper 18 to each of the binding elements 19. In an exemplary embodiment, since the respective rounded shapes of the rounded edges 42 avoided or at least resisted any tearing of, or damage to, the decoupled sheet of paper 18 and especially the respective pairs of tab portions 58a and 58b thereof, the decoupled sheet of paper 18 is capable of being recoupled to the binding 12, as shown in FIGS. 8B-8D.

In several exemplary embodiments, instead of, or in addition to removing and reinserting one or more of the sheets of paper 18, one or more additional sheets of paper, which include cuts and openings that are identical to the cuts 31 and the openings 28, respectively, of the sheets of paper 18, may be coupled to the binding 12, in accordance with the foregoing.

In several exemplary embodiments, the notebook 10 is a notebook or a planner, and sheets of material having openings that are identical to the openings 28 and cuts that are identical to the cuts 31 may be coupled to the binding 12 and/or interchanged with the notebook 10, regardless of the length, width, etc. of the sheets of material.

In view of the foregoing, in several exemplary embodiments, it is clear that the openings 28 and the cuts 31 permit the sheets of paper 18 of the notebook 10 to be removed, repositioned and refilled with ease, and that additional sheets of paper 18 may be inserted into the notebook 10 as desired. In an exemplary embodiment, the shape of each of the openings 28 provides the combination of strength of the sheet of paper 18 in the vicinity of the opening 28 and adequate slack or play in the relative movement between the sheet of paper 18 and the binding elements 19, allowing for both stability of the sheet of paper 18 in the vicinity of the binding 12 and mobility to turn the sheet of paper 18 without tearing or the unintentional or unwanted removal of the sheet of paper 18 from the binding 12 during the turning.

An apparatus has been described that includes a first sheet of material, the first sheet including a generally straight first edge; and a first opening formed through the first sheet, the first opening having a shape, the shape of the first opening defining: generally straight second and third edges of the first sheet, wherein the second and third edges are spaced in a generally parallel relation, wherein the second and third edges are generally perpendicular to the first edge, wherein each of the second and third edges has opposing first and second ends, and wherein each of the second and third edges defines a first dimension; a generally rounded fourth edge of the first sheet, wherein the fourth edge extends from the first end of the second edge to first end of the third edge, wherein the fourth edge is disposed between the first edge and the respective first ends of the second and third edges, wherein the fourth edge defines a radius, and wherein the extension of each of the second and third edges, and the extension of the fourth edge between the respective first ends of the second and third edges, define a second dimension that is generally equal to the sum of the first dimension and the radius; and a generally straight fifth edge of the first sheet, wherein the fifth edge extends from second end of the second edge to the second end of the third edge, wherein the fifth edge is generally parallel to the first edge and generally perpendicular to each of the second and third edges, and wherein the fifth edge defines a third dimension that is generally equal to twice the radius. In an exemplary embodiment, the apparatus includes a circumferentially-extending binding element, the binding element extending through the first opening so that: the first sheet is coupled to the binding element, and the first sheet is permitted to pivot, relative to the binding element, about an axis that is generally perpendicular to a plane in which the binding element circumferentially extends; wherein at least a portion of the binding element is disposed between the fourth edge and the fifth edge in a direction that is generally perpendicular to the first edge; wherein the rounded shape of the fourth edge resists any tearing or damage to the first sheet by the binding element during any pivoting of the first sheet relative to the binding element; wherein the intersection of the fifth edge with the second end of the second edge defines a first corner; wherein the intersection of the fifth edge with the second end of the third edge defines a second corner; and wherein the first and second corners facilitate any pivoting of the first sheet relative to the binding element. In an exemplary embodiment, the binding element defines a diameter; wherein at least respective portions of the first edge and the fourth edge are disposed between opposing tangential points of the binding element; wherein a cut is formed through the first sheet; wherein the cut extends from the first edge to the fourth edge, is generally perpendicular to the first edge, and is disposed generally midway between the respective first ends of the second and third edges; wherein the cut defines a fourth dimension; wherein the cut permits relative movement between the first sheet and the binding element to thereby permit: decoupling of the first sheet from the binding element, and coupling of the first sheet to the binding element subsequent to the decoupling; and wherein the rounded shape of the fourth edge resists any tearing or damage to the first sheet during: the decoupling of the first sheet from the binding element, and the coupling of the first sheet to the binding element subsequent to the decoupling. In an exemplary embodiment, the diameter is about 1 inch, the first dimension is about 2.75 mm, the radius is about 3 mm, the second dimension is about 5.75 mm, the third dimension is about 6 mm, and the fourth dimension is about 4 mm. In an exemplary embodiment, the diameter ranges from about ½ inch to about 1 inch, the first dimension is about 2 mm, the radius is about 2.75 mm, the second dimension is about 4.75 mm, the third dimension is about 5.5 mm, and the fourth dimension is about 3 mm. In an exemplary embodiment, the diameter ranges from about ½ inch to about 1 inch, the first dimension ranges from about 2 mm to about 2.75 mm, the radius ranges from about 2.75 mm to about 3 mm, the second dimension ranges from about 4.75 mm to about 5.75 mm, the third dimension ranges from about 5.5 mm to about 6 mm, and the fourth dimension ranges from about 3 mm to about 4 mm. In an exemplary embodiment, the apparatus includes a cut formed through the first sheet; wherein the cut extends from the first edge to the fourth edge; and wherein the cut is generally perpendicular to the first edge. In an exemplary embodiment, the cut is disposed generally midway between the respective first ends of the second and third edges; and wherein the cut defines a fourth dimension. In an exemplary embodiment, the first dimension is about 2.75 mm, the radius is about 3 mm, the second dimension is about 5.75 mm, the third dimension is about 6 mm, and the fourth dimension is about 4 mm. In an exemplary embodiment, the first dimension is about 2 mm, the radius is about 2.75 mm, the second dimension is about 4.75 mm, the third dimension is about 5.5 mm, and the fourth dimension is about 3 mm. In an exemplary embodiment, the first dimension ranges from about 2 mm to about 2.75 mm, the radius ranges from about 2.75 mm to about 3 mm, the second dimension ranges from about 4.75 mm to about 5.75 mm, the third dimension ranges from about 5.5 mm to about 6 mm, and the fourth dimension ranges from about 3 mm to about 4 mm. In an exemplary embodiment, the ratio of the fourth dimension to the sum of the fourth dimension, the radius and the first dimension ranges from about 0.39 to about 0.41, the ratio of the radius to the sum of the fourth dimension, the radius and the first dimension ranges from about 0.31 to about 0.35, and the ratio of the first dimension to the sum of the fourth dimension, the radius and the first dimension ranges from about 0.26 to about 0.28. In an exemplary embodiment, the first sheet further includes a second opening formed through the first sheet, the second opening having a shape that is identical to the shape of the first opening and thus defining corresponding second, third, fourth and fifth edges of the first sheet, the second opening being spaced from the first opening in a direction parallel to the first edge; wherein the respective fifth edges defined by the first and second openings are generally aligned; and wherein respective tangential points of the respective fourth edges defined by the first and second openings are generally aligned. In an exemplary embodiment, the apparatus includes a circumferentially-extending first binding element, the first binding element extending through the first opening; a circumferentially-extending second binding element coupled to the first binding element, the second binding element extending through the second opening; a second sheet of material; and third and fourth openings formed through the second sheet, the third and fourth openings having shapes that are identical to the first and second openings, respectively; wherein the first and second binding elements further extend through the third and fourth openings, respectively, of the second sheet so that the second sheet is coupled to the first sheet. In an exemplary embodiment, the material is paper. In an exemplary embodiment, the apparatus includes a perforated line formed in the first sheet; wherein the perforated line is spaced in a parallel relation from the first edge so that the first opening is disposed between the first edge and the perforated line. In an exemplary embodiment, the apparatus includes a reinforcing medium coupled to the first sheet, the reinforcing medium extending along the first edge; wherein the first opening extends through the reinforcing medium.

A method has been described that includes providing a sheet of material, the sheet including a generally straight first edge; and forming an opening through the sheet, the opening having a shape, the shape of the opening defining: generally straight second and third edges of the sheet, wherein the second and third edges are spaced in a generally parallel relation, wherein the second and third edges are generally perpendicular to the first edge, wherein each of the second and third edges has opposing first and second ends, and wherein each of the second and third edges defines a first dimension; a generally rounded fourth edge of the sheet, wherein the fourth edge extends from the first end of the second edge to first end of the third edge, wherein the fourth edge is disposed between the first edge and the respective first ends of the second and third edges, wherein the fourth edge defines a radius, and wherein the extension of each of the second and third edges, and the extension of the fourth edge between the respective first ends of the second and third edges, define a second dimension that is generally equal to the sum of the first dimension and the radius; and a generally straight fifth edge of the sheet, wherein the fifth edge extends from second end of the second edge to the second end of the third edge, wherein the fifth edge is generally parallel to the first edge and generally perpendicular to each of the second and third edges, and wherein the fifth edge defines a third dimension that is generally equal to twice the radius. In an exemplary embodiment, the method includes forming a cut through the sheet; wherein the cut extends from the first edge to the fourth edge; and wherein the cut is generally perpendicular to the first edge. In an exemplary embodiment, the cut is disposed generally midway between the respective first ends of the second and third edges; and wherein the cut defines a fourth dimension. In an exemplary embodiment, the first dimension ranges from about 2 mm to about 2.75 mm, the radius ranges from about 2.75 mm to about 3 mm, the second dimension ranges from about 4.75 mm to about 5.75 mm, the third dimension ranges from about 5.5 mm to about 6 mm, and the fourth dimension ranges from about 3 mm to about 4 mm. In an exemplary embodiment, the ratio of the fourth dimension to the sum of the fourth dimension, the radius and the first dimension ranges from about 0.39 to about 0.41, the ratio of the radius to the sum of the fourth dimension, the radius and the first dimension ranges from about 0.31 to about 0.35, and the ratio of the first dimension to the sum of the fourth dimension, the radius and the first dimension ranges from about 0.26 to about 0.28.

It is understood that variations may be made in the foregoing without departing from the scope of the disclosure.

In several exemplary embodiments, the elements and teachings of the various illustrative exemplary embodiments may be combined in whole or in part in some or all of the illustrative exemplary embodiments. In addition, one or more of the elements and teachings of the various illustrative exemplary embodiments may be omitted, at least in part, or combined, at least in part, with one or more of the other elements and teachings of the various illustrative embodiments.

Any spatial references such as, for example, “upper,” “lower,” “above,” “below,” “between,” “bottom,” “vertical,” “horizontal,” “angular,” “upwards,” “downwards,” “side-to-side,” “left-to-right,” “left,” “right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In several exemplary embodiments, while different steps, processes, and procedures are described as appearing as distinct acts, one or more of the steps, one or more of the processes, or one or more of the procedures may also be performed in different orders, simultaneously or sequentially. In several exemplary embodiments, the steps, processes or procedures may be merged into one or more steps, processes or procedures. In several exemplary embodiments, one or more of the operational steps in each embodiment may be omitted. Moreover, in some instances, some features of the present disclosure may be employed without a corresponding use of the other features. Moreover, one or more of the above-described embodiments or variations may be combined in whole or in part with any one or more of the other above-described embodiments or variations.

Although several exemplary embodiments have been described in detail above, the embodiments described are exemplary only and are not limiting, and those skilled in the art will readily appreciate that many other modifications, changes or substitutions are possible in the exemplary embodiments without materially departing from the novel teachings and advantages of the present disclosure. Accordingly, all such modifications, changes or substitutions are intended to be included within the scope of this disclosure as defined in the following claims. In the claims, means-plus-function clauses are intended to cover the structures described herein as performing the recited function and not only structural equivalents, but also equivalent structures.

What is claimed is:

1. An apparatus, comprising:
a first sheet of material, the first sheet comprising a generally straight first edge; and
a first opening formed through the first sheet, the first opening having a shape, the shape of the first opening defining:
generally straight second and third edges of the first sheet,
wherein the second and third edges are spaced in a generally parallel relation,
wherein the second and third edges are generally perpendicular to the first edge,
wherein each of the second and third edges has opposing first and second ends, and
wherein each of the second and third edges defines a first dimension;
a generally rounded fourth edge of the first sheet,
wherein the fourth edge extends from the first end of the second edge to first end of the third edge,
wherein the fourth edge is disposed between the first edge and the respective first ends of the second and third edges,
wherein the fourth edge defines a radius, and
wherein the extension of each of the second and third edges, and the extension of the fourth edge between the respective first ends of the second and third edges, define a second dimension that is generally equal to the sum of the first dimension and the radius;
and
a generally straight fifth edge of the first sheet,
wherein the fifth edge extends from second end of the second edge to the second end of the third edge,
wherein the fifth edge is generally parallel to the first edge and generally perpendicular to each of the second and third edges, and
wherein the fifth edge defines a third dimension that is generally equal to twice the radius.

2. The apparatus of claim 1, further comprising:
a circumferentially-extending binding element, the binding element extending through the first opening so that:
the first sheet is coupled to the binding element, and
the first sheet is permitted to pivot, relative to the binding element, about an axis that is generally perpendicular to a plane in which the binding element circumferentially extends;
wherein at least a portion of the binding element is disposed between the fourth edge and the fifth edge in a direction that is generally perpendicular to the first edge;
wherein the rounded shape of the fourth edge resists any tearing or damage to the first sheet by the binding element during any pivoting of the first sheet relative to the binding element;
wherein the intersection of the fifth edge with the second end of the second edge defines a first corner;
wherein the intersection of the fifth edge with the second end of the third edge defines a second corner; and
wherein the first and second corners facilitate any pivoting of the first sheet relative to the binding element.

3. The apparatus of claim 2, wherein the binding element defines a diameter;
wherein at least respective portions of the first edge and the fourth edge are disposed between opposing tangential points of the binding element;
wherein a cut is formed through the first sheet;
wherein the cut extends from the first edge to the fourth edge, is generally perpendicular to the first edge, and is disposed generally midway between the respective first ends of the second and third edges;
wherein the cut defines a fourth dimension;
wherein the cut permits relative movement between the first sheet and the binding element to thereby permit:
decoupling of the first sheet from the binding element, and
coupling of the first sheet to the binding element subsequent to the decoupling; and
wherein the rounded shape of the fourth edge resists any tearing or damage to the first sheet during:
the decoupling of the first sheet from the binding element, and
the coupling of the first sheet to the binding element subsequent to the decoupling.

4. The apparatus of claim 3, wherein the diameter is about 1 inch, the first dimension is about 2.75 mm, the radius is about 3 mm, the second dimension is about 5.75 mm, the third dimension is about 6 mm, and the fourth dimension is about 4 mm.

5. The apparatus of claim 3, wherein the diameter ranges from about ½ inch to about 1 inch, the first dimension is about 2 mm, the radius is about 2.75 mm, the second dimension is about 4.75 mm, the third dimension is about 5.5 mm, and the fourth dimension is about 3 mm.

6. The apparatus of claim 3, wherein the diameter ranges from about ½ inch to about 1 inch, the first dimension ranges from about 2 mm to about 2.75 mm, the radius ranges from about 2.75 mm to about 3 mm, the second dimension ranges from about 4.75 mm to about 5.75 mm, the third dimension ranges from about 5.5 mm to about 6 mm, and the fourth dimension ranges from about 3 mm to about 4 mm.

7. The apparatus of claim 1, further comprising:
a cut formed through the first sheet;
wherein the cut extends from the first edge to the fourth edge; and
wherein the cut is generally perpendicular to the first edge.

8. The apparatus of claim 7, wherein the cut is disposed generally midway between the respective first ends of the second and third edges; and
wherein the cut defines a fourth dimension.

9. The apparatus of claim 8, wherein the first dimension is about 2.75 mm, the radius is about 3 mm, the second dimension is about 5.75 mm, the third dimension is about 6 mm, and the fourth dimension is about 4 mm.

10. The apparatus of claim 8, wherein the first dimension is about 2 mm, the radius is about 2.75 mm, the second dimension is about 4.75 mm, the third dimension is about 5.5 mm, and the fourth dimension is about 3 mm.

11. The apparatus of claim 8, wherein the first dimension ranges from about 2 mm to about 2.75 mm, the radius ranges from about 2.75 mm to about 3 mm, the second dimension ranges from about 4.75 mm to about 5.75 mm, the third dimension ranges from about 5.5 mm to about 6 mm, and the fourth dimension ranges from about 3 mm to about 4 mm.

12. The apparatus of claim 8, wherein the ratio of the fourth dimension to the sum of the fourth dimension, the radius and the first dimension ranges from about 0.39 to about 0.41, the ratio of the radius to the sum of the fourth dimension, the radius and the first dimension ranges from about 0.31 to about 0.35, and the ratio of the first dimension to the sum of the fourth dimension, the radius and the first dimension ranges from about 0.26 to about 0.28.

13. The apparatus of claim 1, wherein the first sheet further comprises:
a second opening formed through the first sheet, the second opening having a shape that is identical to the shape of the first opening and thus defining corresponding second, third, fourth and fifth edges of the first sheet, the second opening being spaced from the first opening in a direction parallel to the first edge;
wherein the respective fifth edges defined by the first and second openings are generally aligned; and
wherein respective tangential points of the respective fourth edges defined by the first and second openings are generally aligned.

14. The apparatus of claim 13, further comprising:
a circumferentially-extending first binding element, the first binding element extending through the first opening;
a circumferentially-extending second binding element coupled to the first binding element, the second binding element extending through the second opening;
a second sheet of material; and
third and fourth openings formed through the second sheet, the third and fourth openings having shapes that are identical to the first and second openings, respectively;
wherein the first and second binding elements further extend through the third and fourth openings, respectively, of the second sheet so that the second sheet is coupled to the first sheet.

15. The apparatus of claim 1, wherein the material is paper.

16. The apparatus of claim 1, further comprising:
a perforated line formed in the first sheet;
wherein the perforated line is spaced in a parallel relation from the first edge so that the first opening is disposed between the first edge and the perforated line.

17. The apparatus of claim 1, further comprising:
a reinforcing medium coupled to the first sheet, the reinforcing medium extending along the first edge;
wherein the first opening extends through the reinforcing medium.

18. A method comprising:
providing a sheet of material, the sheet comprising a generally straight first edge; and
forming an opening through the sheet, the opening having a shape, the shape of the opening defining:
generally straight second and third edges of the sheet,
wherein the second and third edges are spaced in a generally parallel relation,
wherein the second and third edges are generally perpendicular to the first edge,
wherein each of the second and third edges has opposing first and second ends, and
wherein each of the second and third edges defines a first dimension;
a generally rounded fourth edge of the sheet,
wherein the fourth edge extends from the first end of the second edge to first end of the third edge,
wherein the fourth edge is disposed between the first edge and the respective first ends of the second and third edges,
wherein the fourth edge defines a radius, and
wherein the extension of each of the second and third edges, and the extension of the fourth edge between the respective first ends of the second and third edges, define a second dimension that is generally equal to the sum of the first dimension and the radius;
and
a generally straight fifth edge of the sheet,
wherein the fifth edge extends from second end of the second edge to the second end of the third edge,
wherein the fifth edge is generally parallel to the first edge and generally perpendicular to each of the second and third edges, and
wherein the fifth edge defines a third dimension that is generally equal to twice the radius.

19. The method of claim 18, further comprising:
forming a cut through the sheet;
wherein the cut extends from the first edge to the fourth edge; and
wherein the cut is generally perpendicular to the first edge.

20. The method of claim 19, wherein the cut is disposed generally midway between the respective first ends of the second and third edges; and
wherein the cut defines a fourth dimension.

21. The method of claim 20, wherein the first dimension ranges from about 2 mm to about 2.75 mm, the radius ranges from about 2.75 mm to about 3 mm, the second dimension ranges from about 4.75 mm to about 5.75 mm, the third dimension ranges from about 5.5 mm to about 6 mm, and the fourth dimension ranges from about 3 mm to about 4 mm.

22. The method of claim 20, wherein the ratio of the fourth dimension to the sum of the fourth dimension, the radius and the first dimension ranges from about 0.39 to about 0.41, the ratio of the radius to the sum of the fourth dimension, the radius and the first dimension ranges from about 0.31 to about 0.35, and the ratio of the first dimension to the sum of the fourth dimension, the radius and the first dimension ranges from about 0.26 to about 0.28.
